(19) United States
(12) Patent Application Publication
(10) Pub. No.: US 2019/0109946 A1
(43) Pub. Date: Apr. 11, 2019

(54) SYSTEM, METHOD AND COMPUTER PROGRAM PRODUCT FOR REDUCING UNNECESSARY 911 EMERGENCY CALL CENTER VOLUME

(71) Applicant: Todd M. Hannemann, Racine, WI (US)

(72) Inventor: Todd M. Hannemann, Racine, WI (US)

(21) Appl. No.: 15/725,787

(22) Filed: Oct. 5, 2017

(51) Int. Cl. H04M 3/54; H04W 4/22; H04W 4/02; G06F 17/30

(52) U.S. Cl. CPC H04M 3/54; G06F 17/30241; H04W 4/021; H04W 4/22

(57) ABSTRACT

A system, method and apparatus for alleviating call congestion at a 911 emergency services call center. The system includes automatically connecting a user in need of non-emergency public services with a provider of the non-emergency public services. The system is configured to automatically determine the location of the user and to query a database of non-emergency contact number for one or more public service provider based on one or more jurisdictional boundaries corresponding to the user's location.

### BACKGROUND OF THE INVENTION

The present invention relates to 911 emergency services call centers and, more particularly, to reducing unnecessary 911 call center volume.

Regrettably, a large volume of calls placed to 911 emergency call centers do not require true emergency assistance. These unnecessary 911 calls lead to congestion at emergency call centers which may lead to delays in responding to and deploying emergency assets for true emergencies.

A significant contributor to this problem is that non-emergency contact numbers for public service organizations may be difficult to locate. Unlike emergency services, which are based primarily on the proximity of an emergency response asset to the location of the emergency situation, jurisdictional boundaries or service responsibility determine the ability of the public service provider to respond to a non-emergency situations.

As can be seen, there is a need for improved systems and methods for contacting non-emergency public services to alleviate congestion in 911 emergency services call centers.

### SUMMARY OF THE INVENTION

According to one aspect of the present invention, there is a computerized system for determining and presenting a non-emergency contact number for one or more public services to a user based on a geographic location of the user. The system includes a mobile computing device having a user interface; and a program product comprising machine-readable program code for causing, when executed, the mobile computing device to perform process steps. A first step may include determining a geographic location of the mobile computing device. A next step includes querying a database containing an identifier, a jurisdictional boundary, and a non-emergency contact number for the one or more public services to determine the non-emergency contact number for the one or more public services within the jurisdictional boundary corresponding to the geographic location of the mobile computing device. The mobile computing device is configured to receive the non-emergency contact number for the corresponding one or more public services for the geographic location of the computer. The system may then present the one or more public services on the user interface. Responsive to a user selection of one of the one or more public services, dialing the non-emergency contact number for the selected public service.

According to other aspects of the invention, a computerized system for determining and presenting a non-emergency contact number for one or more public services to a user based on a geographic location of the user is provided. The system includes a server configured to communicate with one or more mobile computing devices. The system also includes a program product comprising machine-readable program code for causing, when executed, the server to perform process steps. The steps include, receiving a geographic location of the one or more mobile computing devices. Querying a database comprising an identifier, a jurisdictional boundary, and a non-emergency contact number. Determining one or more public services based on the jurisdictional boundary corresponding to the geographic location of the one or more mobile computing devices. The steps also include transmitting the non-emergency contact number for the one or more public services to the mobile computing device. In some embodiments, the database may also include, a designation of one or more roles performed by the one or more public services. In these embodiments, the non-emergency contact number is selected based on the jurisdictional boundary and the one or more roles of the public services.

Yet other aspects of the invention include a computerized method for alleviating non-emergency phone call traffic from a 911 emergency call center. The method entails automatically determining a geographic location of a mobile computing device. Automatically querying a database comprising an identifier, a jurisdictional boundary, and a non-emergency contact number for one or more public service providers. The method may also include automatically determining the non-emergency contact number for the one or more public service providers based on the jurisdictional boundary corresponding to the geographic location of the mobile computing device. The method may also present the non-emergency contact number for the one or more public service providers on a user interface of the mobile computing device. Once presented, the user may dial the non-emergency contact number for one of the one or more public service providers.

Yet other aspects of the invention included a computer-readable memory adapted for use by an outsource provider in alleviating the frequency of non-emergency calls from a 911 call center, the computer-readable memory used to direct a server of the outsource provider to perform the steps of: receiving a geographic location of the one or more mobile computing devices; querying a database, in communication with the server, the database comprising an identifier, a jurisdictional boundary, and a non-emergency contact number for one or more public services; and determining the non-emergency contact number for the one or more public service providers based on the jurisdictional boundary corresponding to the geographic location of the mobile computing device. The method includes transmitting the non-emergency contact number for the one or more public services from the server to the mobile computing device. In some embodiments, the database may further include a designation of one or more roles performed by the one or more public services. In these embodiments, the non-emergency contact number may be selected based on the jurisdictional boundary and the one or more roles of the public services.

These and other features, aspects and advantages of the present invention will become better understood with reference to the following drawings, description and claims.

### BRIEF DESCRIPTION OF THE DRAWINGS

FIG. 1 is a schematic view of the non-emergency dialing system in use.

FIG. 2: is a mobile device showing the sign-up screen

FIG. 3: is the mobile device showing the application in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an improved system, method, and computer program product that allows a person in need of non-emergency public services to automatically dial a non-emergency phone number for a selected public service organization.

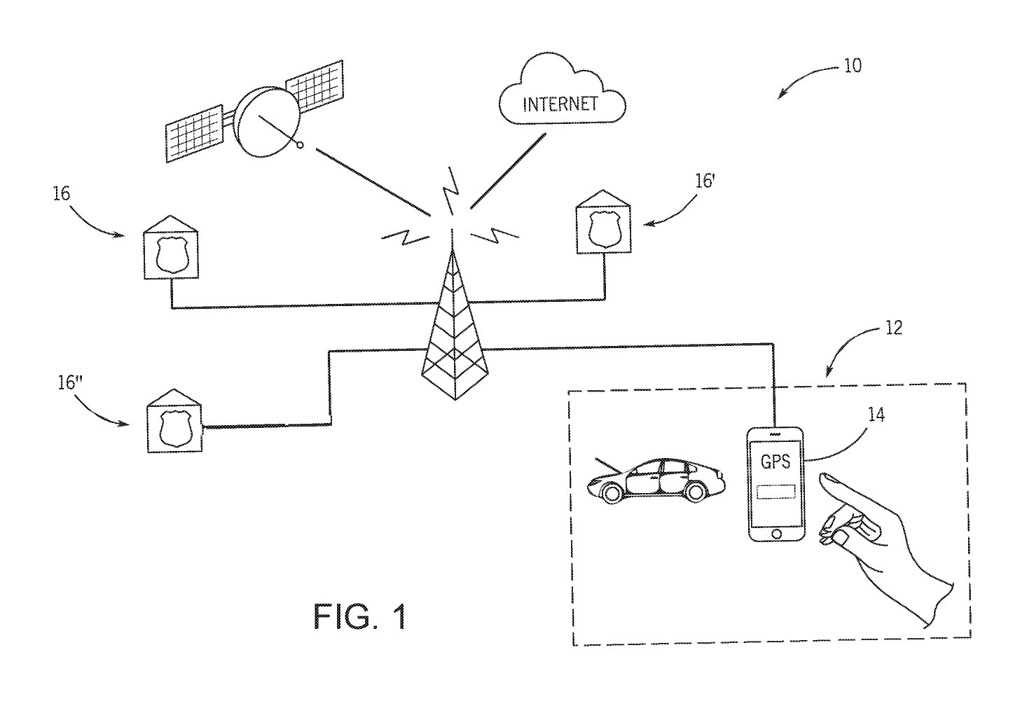

A non-emergency dialing system 10 according to aspects of the present invention is shown in reference FIG. 1. The system includes a person in need of non-emergency services 12 and a mobile computing device 14 configured with a computer program product to interact within the system 10. The system 10 includes a communications system, such as the internet or a cellular communications network, to interconnect the mobile computing device 14 with a non-emergency number for one or more public services organizations. The one or more public service organizations may include a fire department 16, a police department 16′, or a medical service provider 16″. As will be appreciated, the public service organizations may also include a water works, transportation department, animal control, and any of a myriad of public service organizations that service a community.

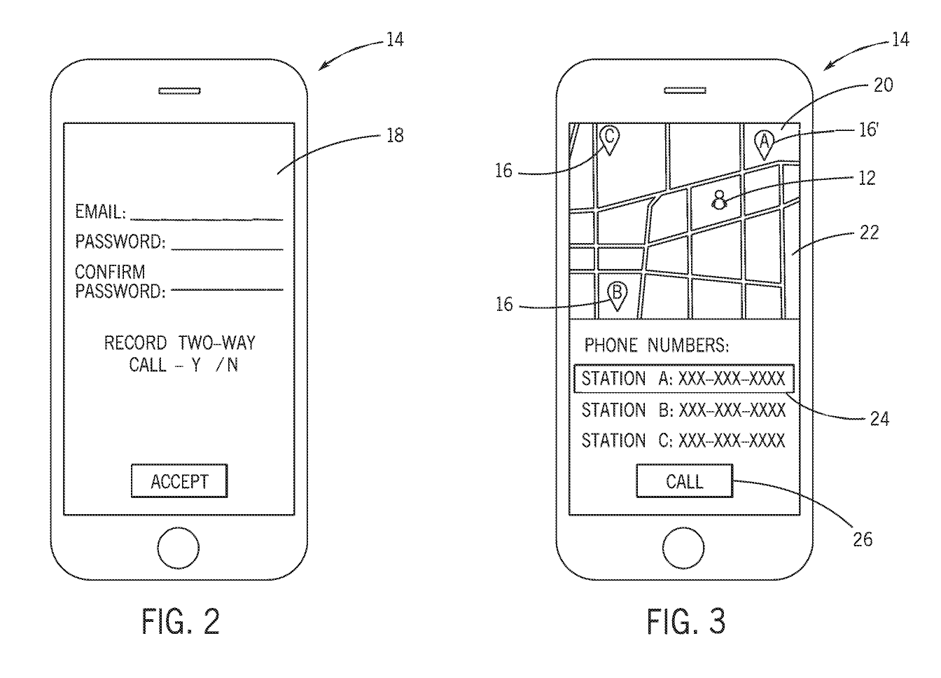

A representative user interface and computer application are shown in reference to FIGS. 2 and 3. The mobile computing device 14 is configured with an application 18 that allows the person in need of non-emergency public services to select and dial the non-emergency contact number for the servicing public service provider.

The application 18 may include a user registration page that allows the user 12 to provide their identification and contact information to the system 10, or limit access to the application 18 to an authorized user 12 of the mobile computing device 14. During sign-in, the user will be prompted to “accept” the Terms and Conditions. Another prompt may ask the user to accept the device permission to record the bi-directional call. 5—An additional prompt will direct user, if selected, to accept the device permission to record the bi-directional voice call. If the user accepts the voice record option; the application 18 may also be configured to convert the recorded voice's audio file to a textual format. The text format may be sent via an emails to the user or public service provider 16. If the user does not accept the voice record option; the call will still take place without the recording or audio to textual format process taking place and no emails will be sent back to the user or Police department.

The application may also be configured to allow the user the ability to block their phone number, or caller identification, from being communicated to the non-emergency. The user may be prompted to confirm or deny making the call “Private”.

As seen reference to FIG. 3, once the user 12 has accessed the system, the application 18 may present a user interface 20 with a non-emergency contact number 24 for one or more public service providers 16, based on the user's needs and/or geographic location. The user 12 may then select the needed public service provider 16 and be connected with the service provider's non-emergency number 24.

Optionally, the application 18 may present a map display, presenting the user's location 12 and the locations of one or more public service providers 16 that provide non-emergency services to the user's location 12. By way of non-limiting example, Station A may represent a law enforcement service. Station B may represent a fire department. Station C may represent a public health or medical service provider.

In other embodiments, the user interface 20 may be configured such that, responsive to a user input or gesture on the map 22 to select a geographic location, the system determines non-emergency contact number 24 for the one or more public service providers 16 correspond to the selected geographic location. By way of non-limiting example, a user may be able to contact a non-emergency service provider 16 for a distant loved one who may be unable or have limited abilities to contact the non-emergency contact number for themselves.

As discussed previously, unlike emergency services, which may be provided based on the geographic proximity of the emergency service provider to the location of the emergency, non-emergency services are provided based on jurisdictional boundaries, which may be irregularly defined, or not known to the user 12. For example, a user 12 may be unaware that their location is serviced by a county law enforcement entity, even though they may believe that they are located within a city or town. Likewise, a city may be divided into precincts and the user 12 may not know which precinct services their location. Likewise, certain lower density services, such as animal control, may have boundaries that differ from other public services for which there may be a higher demand or density of service providers 16.

In other instances, the delineation of roles and responsibilities for a particular public service may vary widely between one governmental unit and another. These differences may depend on policies, staffing, and scope of responsibility for the governmental unit. Accordingly, the system 10 is configured to determine the appropriate non-emergency public service provider that has responsibility for the needed service at the locale where the user 12 needs the service.

When the application 18 is launched the application 18 may query one or more geo position determining systems, such as a global positioning system (GPS) in the mobile device 14 to determine the location of the user 12. The mobile device 14 may then communicate the user's location to a server hosting the system 10. Based on the user's location 12, the system 10 queries a database containing the identification of the one or more public services 16 according to the jurisdictional boundary that the user is located and/or the delineation of roles within the one or more governmental units where the user 12 is located.

The governmental unit or the one or more public services 16 within a jurisdiction may register with the system 10 to provide their non-emergency contact information and a designation of services provided by the public service entity. Alternatively, an administrator of the system 10 may assemble and compile the jurisdictional and delineation of roles and responsibilities. The system 10 may be provided as a free service or on a subscription or fee basis for either the user 12 or the participating public service provider 16 or governmental entity.

As will be appreciated, the user interface 20 may alternatively present indicia, such as a graphical icon, corresponding to one or more public services 16. By way of non-limiting example: a shield designating a law enforcement activity, a medical symbol for a medical or public health service, a flame for fire services; an animal for animal control services, a faucet for public water services, etc. The user 12 may then select the indicia on the user interface 20 corresponding to their needed service. Responsive to the user selection, the application queries the database to determine the public service provider 16 responsible for providing the requested service to the location where the user 12 is located.

In the case where the user applies an input to the map 22 presented on the user interface 20, to select a geographic location, the coordinates for the selected geographic location are transmitted to the system server 10. In this instance, the one or more public service providers 16 and their corresponding non-emergency contact number 24 are communicated to the mobile device 14 for presentation on the user interface 20. The user interface 20 may also be configured so that the user may manipulate the map with a gesture, such as for zooming in/out, or for panning, to locate a desired geographic location.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A computerized system for determining and presenting a non-emergency contact number for one or more public services to a user based on a geographic location of the user, the system comprising:
a mobile computing device having a user interface; and
a program product comprising machine-readable program code for causing, when executed, the mobile computing computer to perform the following process steps:
determining a geographic location of the mobile computing device;
querying a database comprising an identifier, a jurisdictional boundary, and a non-emergency contact number for the one or more public services to determine the non-emergency contact number for the one or more public services within the jurisdictional boundary corresponding to the geographic location of the mobile computing device; and
receiving the non-emergency contact number for the corresponding one or more public services for the geographic location of the computer.

2. The computerized system of claim 1, further comprising:
presenting the one or more public services on the user interface.

3. The computerized system of claim 2, further comprising:
responsive to a user selection of one of the one or more public services, dialing the non-emergency contact number for the selected public service.

4. A computerized system for determining and presenting a non-emergency contact number for one or more public services to a user based on a geographic location of the user, the system comprising:
a server configured to communicate with one or more computing devices; and
a program product comprising machine-readable program code for causing, when executed, the server to perform the following process steps:
receiving a geographic location of the one or more mobile computing devices;
querying a database comprising an identifier, a jurisdictional boundary, and a non-emergency contact number to identify one or more public services based on the jurisdictional boundary corresponding to the geographic location of the one or more mobile computing devices; and
transmitting the non-emergency contact number for the one or more public services to the mobile computing device.

5. The computerized system of claim 4, the wherein the database further comprises:
a designation of one or more roles performed by the one or more public services.

6. The computerized system of claim 5, wherein the non-emergency contact number is selected based on the jurisdictional boundary and the one or more roles of the public services.

7. A computerized method for alleviating non-emergency phone call traffic from a 911 emergency call center comprising:
automatically determining a geographic location of a mobile computing device;
automatically querying a database comprising an identifier, a jurisdictional boundary, and a non-emergency contact number for one or more public service providers;
automatically determining the non-emergency contact number for the one or more public service providers based on the jurisdictional boundary corresponding to the geographic location of the mobile computing device.

8. The computerized method of claim 7, further comprising:
presenting the non-emergency contact number for the one or more public service providers on a user interface of the mobile computing device.

9. The computerized method of claim 8, further comprising:
responsive to a user selection of one of the one or more public service providers, dialing the non-emergency contact number for the selected public service providers.

10. A computer-readable memory adapted for use by an outsource provider in alleviating the frequency of non-emergency calls from a 911 call center, the computer-readable memory used to direct a server of the outsource provider to perform the steps of:
receiving a geographic location of the one or more mobile computing devices;
querying a database, in communication with the server, the database comprising an identifier, a jurisdictional boundary, and a non-emergency contact number for one or more public services
determining the non-emergency contact number for the one or more public service providers based on the jurisdictional boundary corresponding to the geographic location of the mobile computing device.

11. The computer readable memory of claim 10, further comprising:
transmitting the non-emergency contact number for the one or more public services from the server to the mobile computing device.

12. The computer readable memory of claim 11, the wherein the database further comprises:
a designation of one or more roles performed by the one or more public services.

13. The computerized system of claim 12, wherein the non-emergency contact number is selected based on the jurisdictional boundary and the one or more roles of the public services.
